(19) United States
(12) Patent Application Publication
(10) Pub. No.: US 2025/0173571 A1
(43) Pub. Date: May 29, 2025

(54) Chip Architecture Gradient-Descent

(71) Applicant: X Development LLC, Mountain View, CA (US)

(72) Inventor: Dino Ruic, Santa Clara, CA (US)

(21) Appl. No.: 18/829,662

(22) Filed: Sep. 10, 2024

Related U.S. Application Data
(60) Provisional application No. 63/602,709, filed on Nov. 27, 2023.

(51) Int. Cl. G06N 3/082

(52) U.S. Cl. CPC G06N 3/082

(57) ABSTRACT

The technology involves neural networks that are implementable in hardware. These networks can reduce computation speed and cost for execution of complex or other training objectives. The process involves co-optimizing a neural network with its associated hardware implementation cost to derive a hardware solution. This includes using a hardware cost function in conjunction with an architecture gradient descent process. The resultant hardware solution may be implemented in hardware such as an FPGA or ASIC. A method includes identifying a training objective to be executable by a hardware computing device and identifying a hardware cost corresponding to a set of features of the hardware computing device. The hardware cost is applied to a neural network during training to achieve the training objective. The method generates a sparsity pattern in a set of layers of the neural network and generates a hardware implementation of the training objective according to the sparsity pattern.

### CROSS-REFERENCE TO RELATED APPLICATIONS

This application claims the benefit of the filing date and priority to U.S. Provisional Patent Application No. 63/602,709, filed Nov. 27, 2023, the entire disclosure of which is incorporated herein by reference.

### BACKGROUND

Machine learning can be used in a wide variety of applications, such as natural language processing, image processing and the like. A trained neural network is typically employed to provide a machine learning model for a specific task. However, while such networks may be implemented in various types of computing systems, the specific hardware architecture can impact the efficiency of the neural network. In addition, conventional approaches for neural networks may provide a poor fit for certain types of functions, such as non-linear functions.

### SUMMARY

The technology relates to machine learning systems, including the design of neural networks that are implementable in hardware. More particularly, the technology involves co-optimizing a neural network with its associated hardware implementation cost in order to obtain an efficient hardware solution for the neural network. This can include using a hardware cost function in conjunction with an architecture gradient descent process. The resultant hardware solution may be implemented in a field-programmable gate array (FPGA), integrated circuit (IC) such as an application-specific IC (ASIC) or other hardware device.

Aspects of the technology involve creating a unique and highly efficient hardware implementation of a machine learning algorithm by including the hardware cost in the training of the neural network. The hardware cost can include a logic cost (e.g., which may correspond to the number of multiply-accumulate units needed), as well as a placement and/or routing cost. The placement and routing cost(s) may include factors such as area (e.g., can the design be placed and routed compactly), timing (e.g., can the design be placed and routed as to hit a high frequency, given that long routes may prevent that), and power (e.g., can the design be placed and routed in a small power envelope according to a power criterion). Thus, the placement and routing costs may be considered as a set of spatiotemporal costs. Moreover, sparsity of the neural network may be leveraged for a specific hardware implementation, in accordance with the hardware cost. Thus, the structure of the sparse neural network can be mapped directly into the hardware configuration (e.g., map into the FPGA or ASIC) for optimal performance, power usage, and/or latency.

The technology involves training sparse neural networks, for instance with a sparsity that may be on the order of less than 1-10% (where less than 1-10% of elements are non-zero). For instance, a sparsity pattern may be employed that is optimal for a combination of predictive capability and which can also be mapped efficiently to hardware. In contrast, a systolic array would multiply numbers by 0, and by requiring such multiplications therefore 90-99% of the power usage would be wasted.

According to one aspect of the technology a method comprises: identifying a training objective to be executable by a hardware computing device; identifying a hardware cost corresponding to a set of features of the hardware computing device; applying, by one or more processors, the hardware cost to a neural network during training to achieve the training objective; generating, via the training according to the applied hardware cost, a sparsity pattern in a set of layers of the neural network; and generating a hardware implementation of the training objective in the hardware computing device according to the sparsity pattern.

The sparsity pattern may be generated in one or more layers of the set of layers of the neural network based on adjustment of weights or biases in the one or more layers. Here, the adjustment may include pruning one or more of the weights in the one or more layers. Alternatively or additionally, the adjustment may further include pruning routes in the one or more layers. In this case, the method may further comprise varying a pruning threshold for pruning the routes.

Alternatively or additionally to any of the above, the sparsity pattern may be generated by training a loss function that accounts for a prediction loss and the applied hardware cost. Training the loss function may be performed by applying a gradient descent approach to minimize the loss function. Alternatively or additionally to any of the above, the sparsity pattern may be generated by training a loss function to account for the hardware cost. Alternatively or additionally to any of the above, the hardware cost may include at least one of a logic cost or a set of spatiotemporal costs. In this case, the set of spatiotemporal costs may include at least one of a placement cost or a routing cost. Here, the at least one of the placement cost or the routing cost may include one or more factors including area, timing, or power.

The hardware computing device may be a field-programmable gate array (FPGA) device. Alternatively the hardware computing device is an application-specific integrated circuit (ASIC) or other IC-based device. Alternatively or additionally to any of the above, the training objective to be executable by the hardware computing device may be a non-linear function.

According to another aspect of the technology, a system is provided that comprises memory configured to store at least one of a training objective, a hardware cost, or a hardware implementation of the training objective; and one or more processors operatively coupled to the memory. The one or more processors are configured to: identify the training objective to be executable by a hardware computing device; identify the hardware cost corresponding to a set of features of the hardware computing device; apply the hardware cost to a neural network during training to achieve the training objective; generate via the training according to the applied hardware cost, a sparsity pattern in a set of layers of the neural network; and generate the hardware implementation of the training objective in the hardware computing device according to the sparsity pattern.

The sparsity pattern may be generated in one or more layers of the set of layers of the neural network based on adjustment of weights or biases in the one or more layers. The sparsity pattern may be generated by training a loss function that accounts for a prediction loss and the applied hardware cost. The sparsity pattern may be generated by training a loss function to account for the hardware cost. Moreover, the hardware cost may include at least one of a logic cost or a set of spatiotemporal costs.

According to a further aspect of the technology, a non-transitory computer-readable medium is provided having instructions stored thereon. The instructions, when executed by one or more processors of a computing system, is able to perform a method comprising: identifying a training objective to be executable by a hardware computing device; identifying a hardware cost corresponding to a set of features of the hardware computing device; applying the hardware cost to a neural network during training to achieve the training objective; generating, via the training according to the applied hardware cost, a sparsity pattern in a set of layers of the neural network; and generating a hardware implementation of the training objective in the hardware computing device according to the sparsity pattern.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIGS. 1A-B illustrate example neural network layers in accordance with aspects of the technology.

FIG. 2 is an example multi-layer neural network that may be employed according to aspects of the technology.

FIGS. 3A-D illustrate example weighting information for an exemplary non-linear function.

FIGS. 4A-D illustrate example biasing information for the exemplary non-linear function.

FIG. 5A illustrates a plot of the exemplary non-linear function.

FIG. 5B illustrates a plot of the output prediction of the neural network for the exemplary non-linear function.

FIG. 5C illustrates absolute error for the neural network for the non-linear function.

FIGS. 6A-D illustrate example weighting information for an exemplary non-linear function, in which the neural network has been trained according to aspects of the technology.

FIGS. 7A-D illustrate example biasing information for the exemplary non-linear function, in which the neural network has been trained according to aspects of the technology.

FIG. 8A illustrates a plot of the exemplary non-linear function, in which the neural network has been trained according to aspects of the technology.

FIG. 8B illustrates a plot of the output prediction of the neural network for the exemplary non-linear function, in which the neural network has been trained according to aspects of the technology.

FIG. 8C illustrates absolute error for the neural network for the non-linear function, in which the neural network has been trained according to aspects of the technology.

FIG. 9 illustrates a system configured to implement chip architecture gradient descent according to aspects of the technology.

FIG. 10 illustrates an example method in accordance with aspects of the technology.

### DETAILED DESCRIPTION

By incorporating the hardware cost in the training of a neural network that is designed to address a particular machine learning task, an efficient hardware implementation can be designed. As discussed herein the routing cost expressed as the length of a wire (e.g., the half-perimeter wire length, or HPWL) regularizes the neural network architecture to prefer short routes, so that longer routes may be used when it is necessary to reach a training objective. The training objective may be a particular function that the neural network is designed to solve, e.g., ƒ(a,b)=a²+b².

A neural network includes a number of layers. One or more inputs represent a set of features, which are fed into a respective layer of the network. Each input may be separately weighted, to give more importance to certain features that contribute more towards the task training (learning) of the machine learning model. Biases can also be introduced to adjust thresholds for an activation function of a given layer. By way of example, a rectified linear unit (ReLU) function is one type of activation function that may be employed.

The weighting and biases are fitted to the data during training. Weights and routes for the neural network can be pruned to create a sparse matrix-vector multiplication (a sparse pattern), which can be implemented in hardware according to the hardware cost.

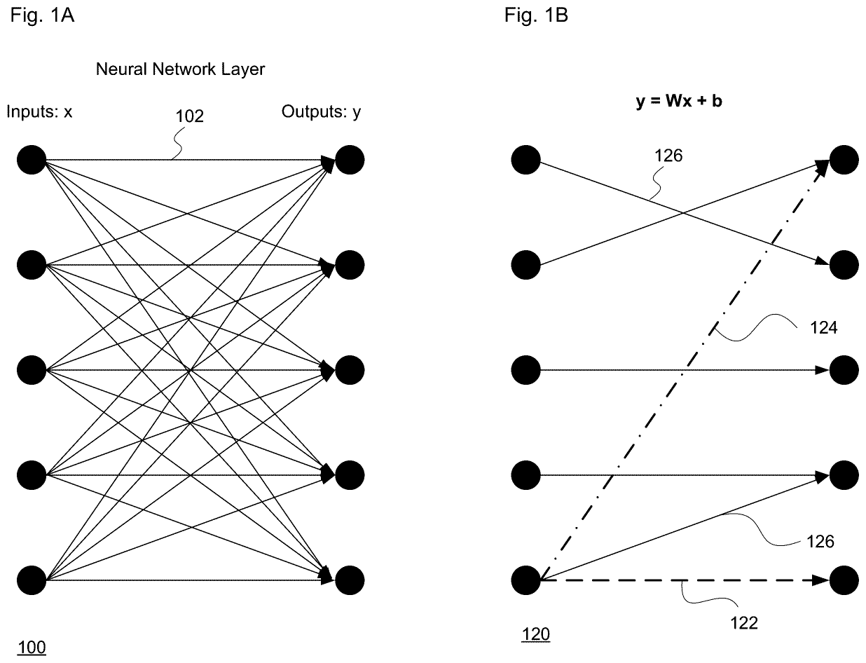

An example layer 100 is shown in FIG. 1A, in which there are a set of inputs (x) to the layer and a set of outputs (y) from the layer. It is possible for each input to be connected to each output (i.e., a fully connected layer), as shown by the arrows 102 in this example. However, fully connected layers may be resource intensive, for instance from a processing resource and/or power consumption standpoint. Thus, routing every input to every output in a hardware implementation of the neural network may not be feasible.

Note that in some situations, dense layer systolic arrays can be used. Systolic arrays use the properties of addition to accumulate, thereby avoiding routing every input to every output. However, systolic arrays may place limitations on the architecture of the neural network, including latency issues. Moreover, systolic arrays may not handle general sparsity effectively, and also may not efficiently handle graph-like connectivity such as skip layer connections.

As an alternative to systolic arrays, an approach using sparse connectivity can be employed, in which the possible connections (routes) between the inputs and outputs are limited for a given layer. An example 120 of this is shown in FIG. 1B, which indicates that there is a short route (dashed line 122) and a long route (dash-dot line 124) from a given input node to different output nodes. There may be one or more intermediary-length routes 126 as well.

Implementing a layer in the neural network can be represented by: y=Wx+b, in which W is the weighting and b accounts for the biases(s). Assessing the routing cost, which can help identify sparsity patterns, may be done according to the following equation:

$${y}_{i} = {\sum }_{j} {w}_{ij} {x}_{j} + {b}_{i}$$

Here, yᵢ is the i^{th} component of the output. The input components xⱼ of the input are incorporated by the affine transformation Wx+b.

One aspect of the technology involves discovering (or otherwise generating) sparsity patterns that are efficient by training using a loss function that accounts for the overall hardware implementation cost in addition to a prediction loss. Such a loss function can be expressed as:

loss(W,b,in,out)=prediction_loss(W,b,in,out)+implementation_cost(W,b),

where “in” identifies the inputs and “out” identifies the outputs.

The implementation cost is proportional to:

$$implementation\_cost ( W ) ∝ \sum ( \sqrt{( \vert W \vert} * distance )$$

Here, distance is the distance between an input (x) and an output (y) for a given layer in the neural network. For a weight matrix with indices i, j, the distance between input and output could be: distance (i,j)=1+|i−j|. Thus, it can be seen that larger weights and distances between inputs and outputs are more “expensive” than smaller weights and distances.

One way to map the sparsity pattern to a particular hardware configuration may involve an evaluation of the computational units to be implemented in the hardware to achieve the particular training objective (e.g., an operation or other function to be executed by the system). By way of example only, consider that there is a predefined structure of multiply accumulate units laid out on a “canvas”, e.g., in columns according to the layers of the neural network. Then one can define quite accurately what it would “cost” to utilize one of these units in terms of power, and also obtain a reasonable estimate of what it would “cost” to lay out a route between these units in the physical hardware device. This could be done for the design of an ASIC. This could also be done for an FPGA where one could define a “soft” neural network architecture of arithmetic units within the limitations of the FPGA, and then use the knowledge of the FPGA architecture to define a routing cost. For instance, if the system can identify how routing impacts the FPGA clock speed (e.g., long routes are “bad” because they take more time to traverse), then one can directly derive a cost model. Alternatively or additionally, there may be a maximum number of routes or arithmetic units. Here, the process can penalize using more than that number of routes or arithmetic units. Other approaches could also be used, depending on the specific hardware type and any constraints (e.g., power, clock speed, computation unit type(s), number of layers of the circuitry, fabrication cost, product size, etc.).

According to one approach, a goal can be to set weights to zero if the distance is large—in other words, exceeds some threshold distance. And so in this example for implementation cost, one could implement the cost proportional to the distance and multiply by the square root of the weight, so that the loss gradient is steeper around 0 (i.e., goes faster to zero). The distance can be chosen like this if one were to imagine that the input components are simply laid out in a series from top to bottom, and may also be the simplest approach. This is just one possible choice. Other choices for the implementation cost may be used in the alternative.

According to one aspect of the technology, the prediction is compared to actual observation (which is the loss), then back propagated through the model so that prediction becomes more accurate (in other words, decreasing the prediction loss). This can be done by applying a gradient descent approach to minimize the loss function. By way of example, a network of a few dense layers can be trained using an ADAM-type approach. This approach is described by Kingma and Ba in “Adam: A Method for Stochastic Optimization”, published Jan. 30, 2017, which is incorporated herein by reference.

Thus, assume the neural network implements a function ƒ, and there is a loss L(ƒ) to be minimized using ADAM or another gradient descent technique. In supervised learning, the loss typically contains all of the training data and is given by, e.g., the mean-squared error of what the network predicts and what the data indicates it should be. With back-propagation, one can take the derivative of the loss L(ƒ) with respect to the network parameters (here, W and b), which will indicate how the prediction error changes if the weights and biases of the network are adjusted. An optimization approach such as ADAM would use this gradient to adjust the weights and biases to get closer to an optimum solution.

For a chip architecture gradient-descent approach, as noted above, the hardware cost desirably includes a logic cost as well as a spatiotemporal cost, which includes placement and/or routing costs. The routing cost, such as HPWL, regularizes the neural network architecture to prefer short routes. The system may train the neural network model including the hardware implementation cost in the loss. Then, after that is done, weights can be pruned that are very small (e.g., below a pruning threshold). For instance, the pruning threshold can be chosen by checking if the prediction loss deteriorates. As an example only, the system may set the threshold to 0.01, prune, and check how much worse the predictions become. Then the system can adjust the threshold to 0.02, prune, and check how much worse the predictions become with the change to the threshold. This may be done one or more times until the predictions satisfy some design criteria.

It can be seen that there may be a trade-off between desired accuracy in the prediction and the hardware cost. The pruning threshold works hand-in-hand with the hardware cost. Thus, if there is a large hardware cost, all weights can be driven towards zero. Choosing a lower threshold will prune less weights than if the hardware cost is large. Basically, there is a continuum of solutions that can be tuned by varying the hardware cost by multiplying it by a constant and then choosing some pruning threshold. If the hardware cost goes to zero, one can recover the standard machine learning approach. Then if the hardware cost is slightly increased, there may be a region where a significant amount of weights can be pruned without degrading the prediction loss. Note that if the hardware cost gets too large, the prediction loss will degrade and the result may be unsuitable for a hardware implementation.

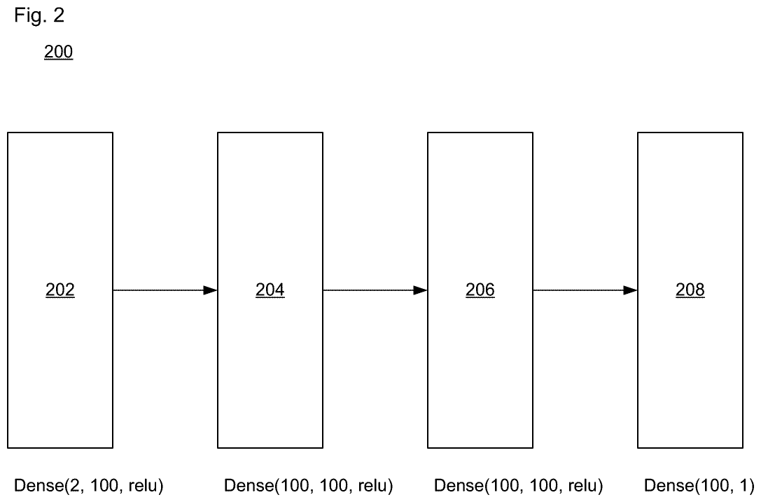

The arrangement as shown in example 200 of FIG. 2 was used to evaluate the gradient descent approach to train the non-linear (square) function ƒ(a,b)=a²+b². Squares cannot be represented using linear transformations and ReLU functions. Rather, the neural network will learn how to interpolate the square function.

As illustrated in this example, the neural network has four layers: an input layer 202, hidden layers 204 and 206, and an output layer 208 as follows:
Input layer: Dense(2, 100, ReLU)
Hidden layer: Dense(100, 100, ReLU)
Hidden layer: Densc(100, 100, ReLU)
Output layer: Dense(100, 1)

The input layer has 2 nodes, while the remaining layers each have 100 nodes. A ReLU function, which is applied at the outputs of the first three layers, is a piecewise linear function that will output the input directly if it is a positive value; otherwise, it will output zero. Dense(2, 100, ReLU) means this is a layer with 2 inputs and 100 outputs. That means W is a 100×2 matrix. Hence, b also has a dimension of 100, where each output has an associated bias. After the calculation is done, a component-wise ReLU is applied.

The hidden layers 204 and 206 each have 100 inputs and 100 outputs. The output layer 208 takes as its inputs the 100 outputs from hidden layer 206, and has a single output. Note that the output layer 208 does not have an activation function.

### Testing

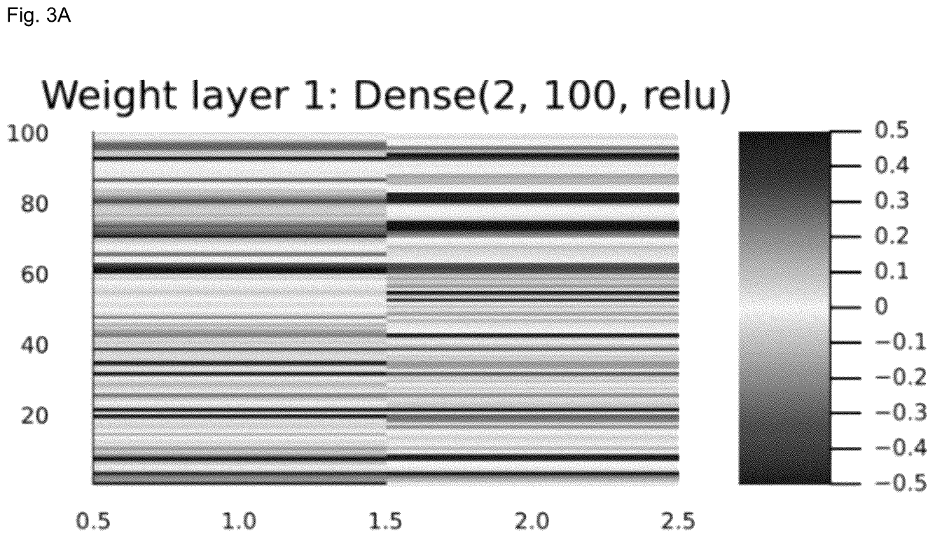

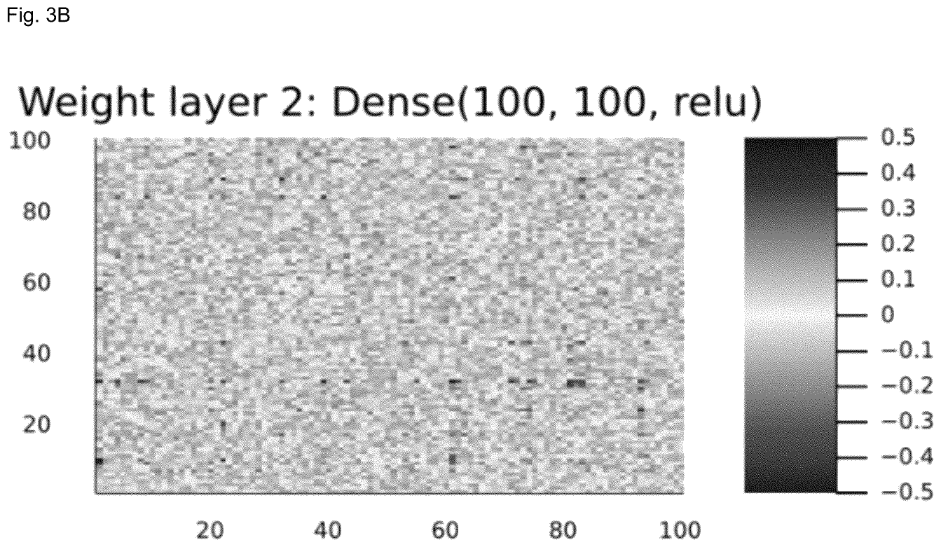

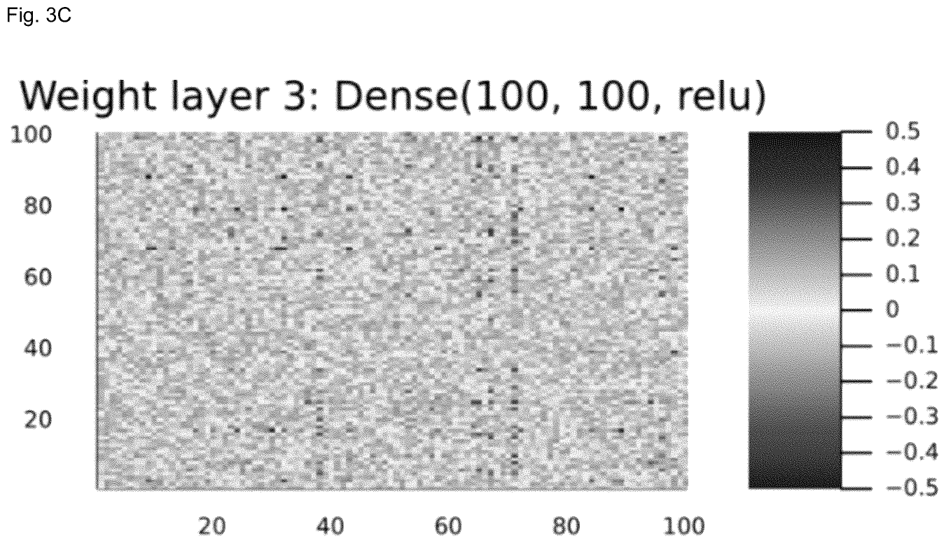

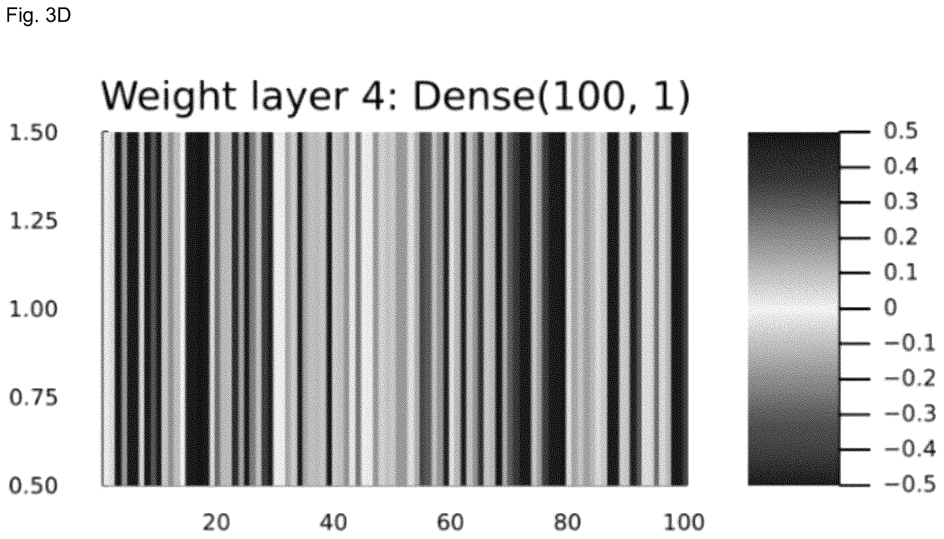

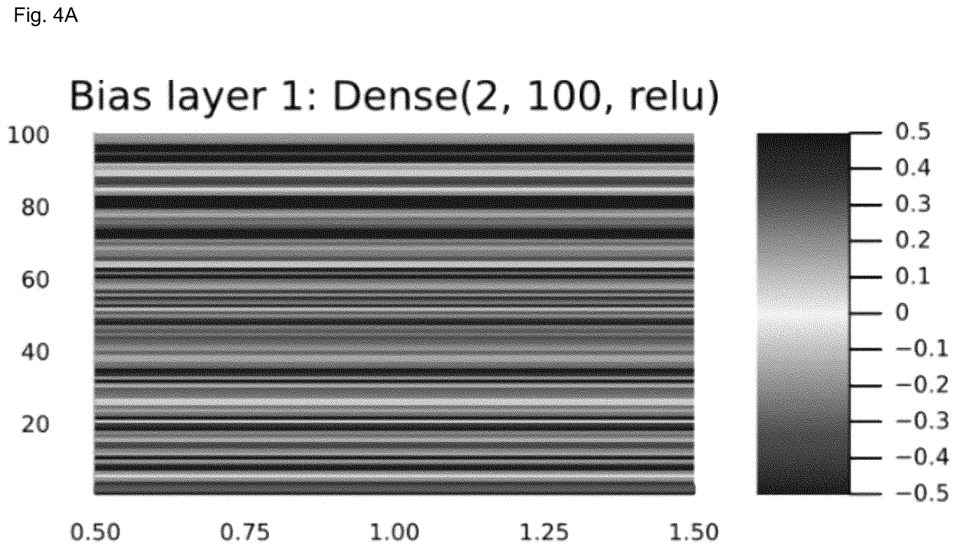

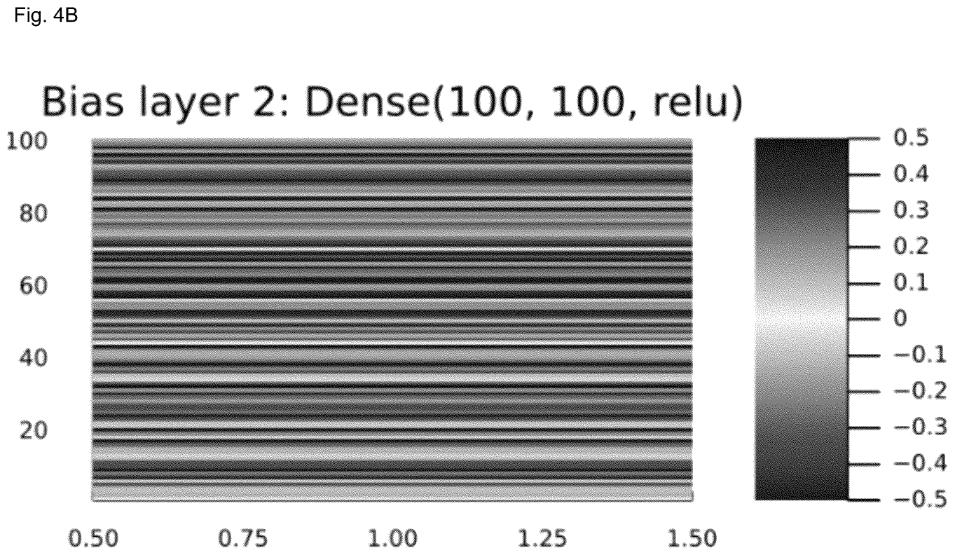

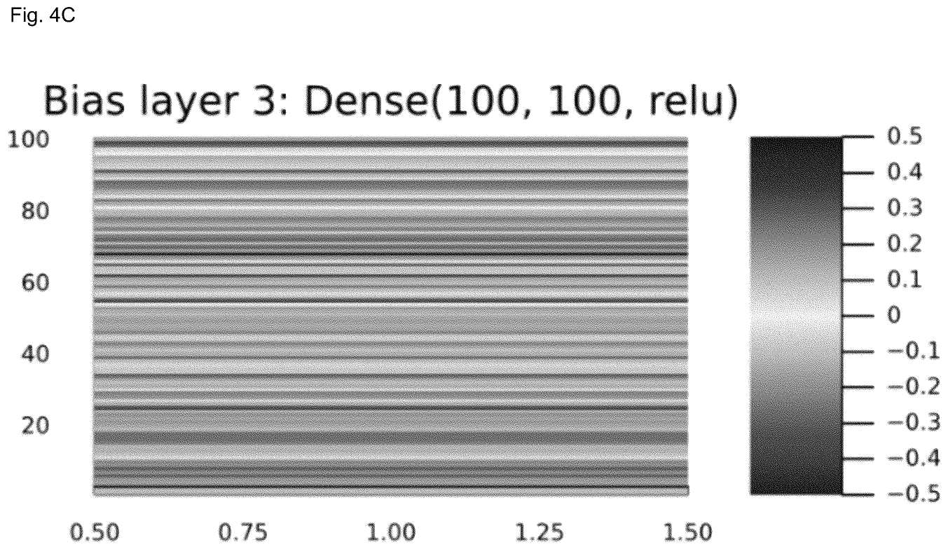

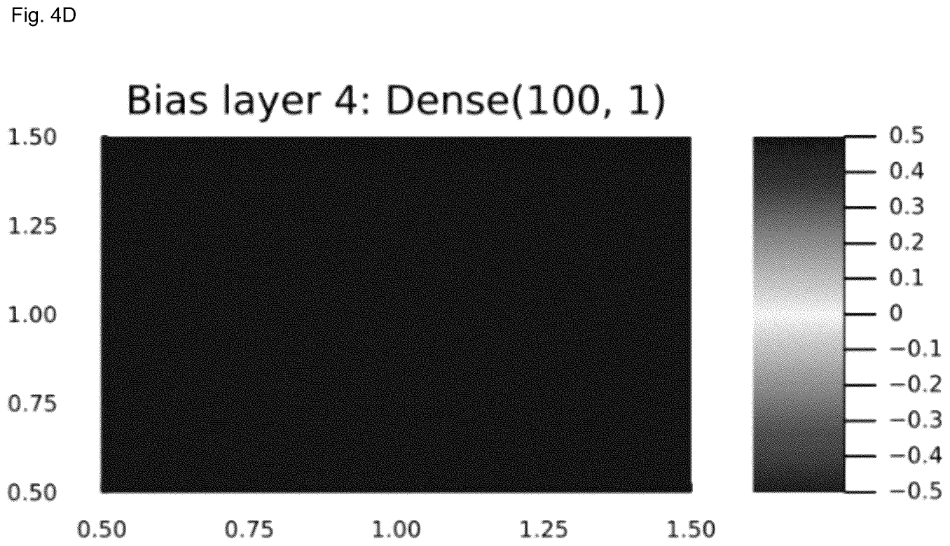

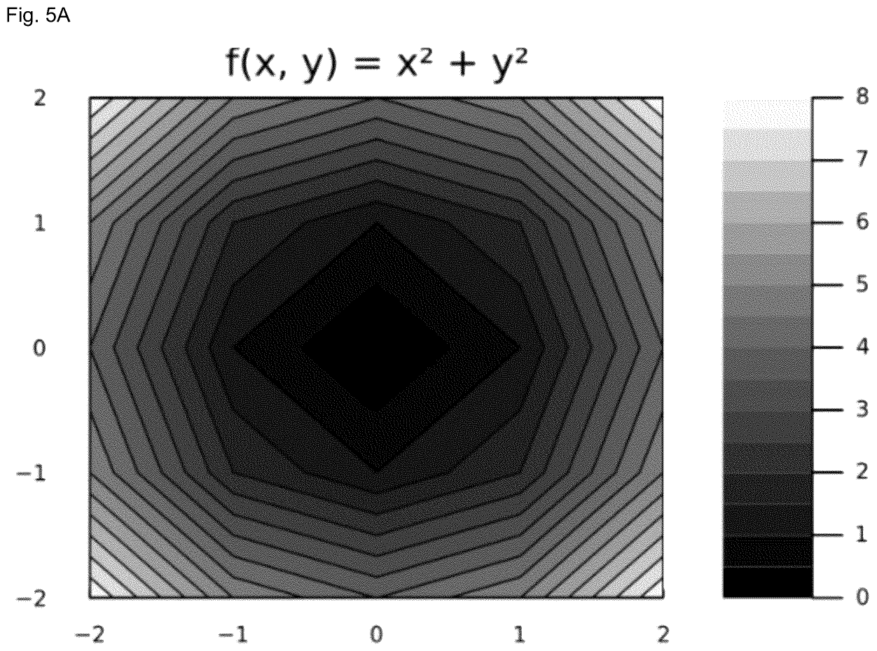

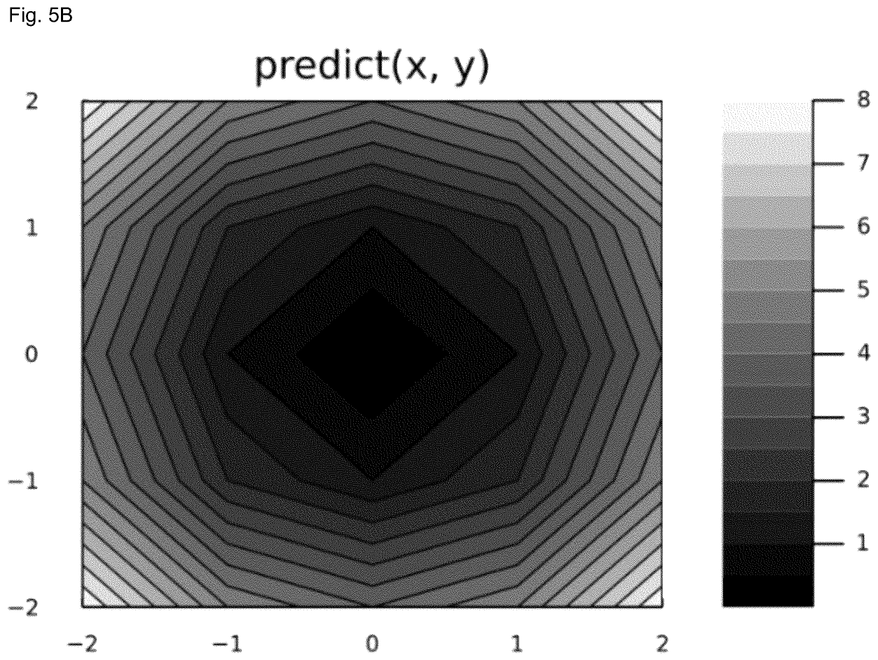

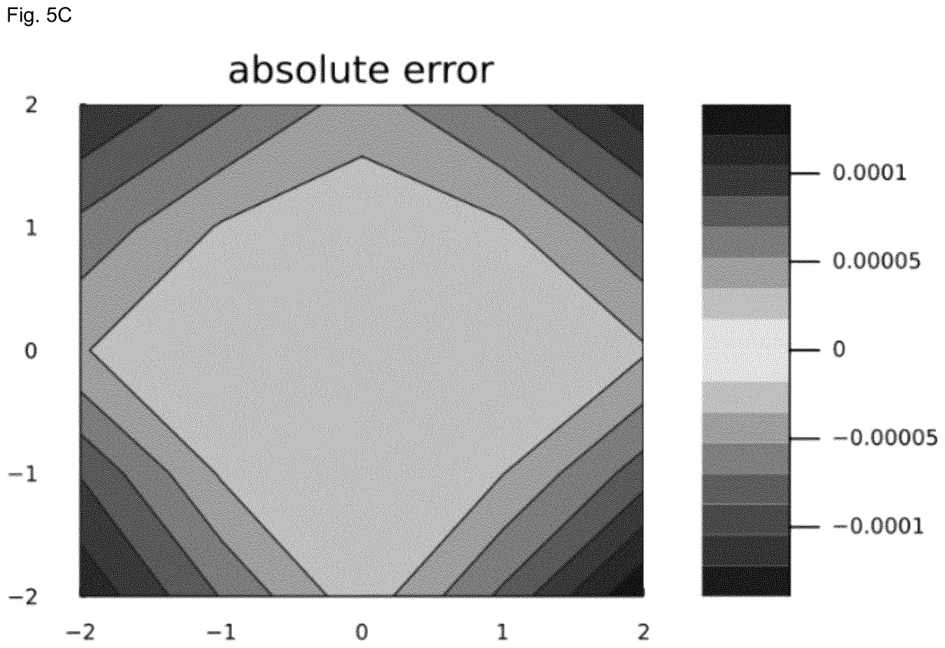

In an example, an ADAM-type approach was used when training the square function ƒ(x,y)=x²+y². In this example, 25 points were sampled from ƒ(x,y), and ADAM was used to train the model using a mean-squared error prediction loss: loss (in, out)=MSE (prediction (in), out). FIGS. 3A-D illustrate plots for the weights for the four layers. FIGS. 4A-D illustrate plots for the biases for the four layers. FIG. 5A illustrates a plot of the function, FIG. 5B illustrates a plot of the output predict (x,y) of the neural network, and FIG. 5C illustrates absolute error.

In this example, the system is able to train a neural network to match the training points very effectively. However, there are more than 20,000 weights. Moreover, as can be seen from FIGS. 3A-D, the weights appear to be randomly distributed. Actually, they were chosen such that they cancel each other out to produce the desired training function. The problem in this example is that there is no reason for the weights to really regularize themselves into something that can be efficiently implemented in a hardware solution. While the trained neural network to implement this function may be achieved using a systolic array, this hardware solution may be inefficient in different respects, such as the size of the device, power usage, speed/throughput, etc.

More particularly, FIGS. 3A-D present plots of the weight matrices W of each of the layer where the x-axis is the column index and the y-axis is the row index. The color bar on the right represents the value of the weight where white means ˜0, red means positive and blue means negative. A Dense(2, 100, −) matrix is a matrix such that A x=y where x is two-dimensional and y is 100-dimensional, so A has 2 columns and 100 rows. In the plots in FIGS. 3A-D, the color bar has been clipped to a range from −0.5 to +0.5 in order to visualize which values got to approximately zero. While there are values with magnitude larger than 0.5, they would not be too much bigger than that, and are not represented in these figures.

FIGS. 4A-D present the bias vectors b of each layer. Since they are vectors, they only have one column. The row number is dependent on the row number of the matrix. FIGS. 5A-C represent the target model, the prediction and the error. FIG. 5A is for function ƒ(x, y)=x²+y² plotted where the x-axis is x, the y-axis is y and the value of ƒ(x, y) is represented by the color. FIG. 5B is predict (x, y), which is the prediction of the trained model (without hardware implementation cost) trained on 25 sampling points of ƒ(x, y). Since it is hard to see a difference, the error err (x, y)=ƒ(x, y)−predict (x, y) was also plotted as shown in FIG. 5C. It can be seen that the error is very small, which shows that the prediction works very well.

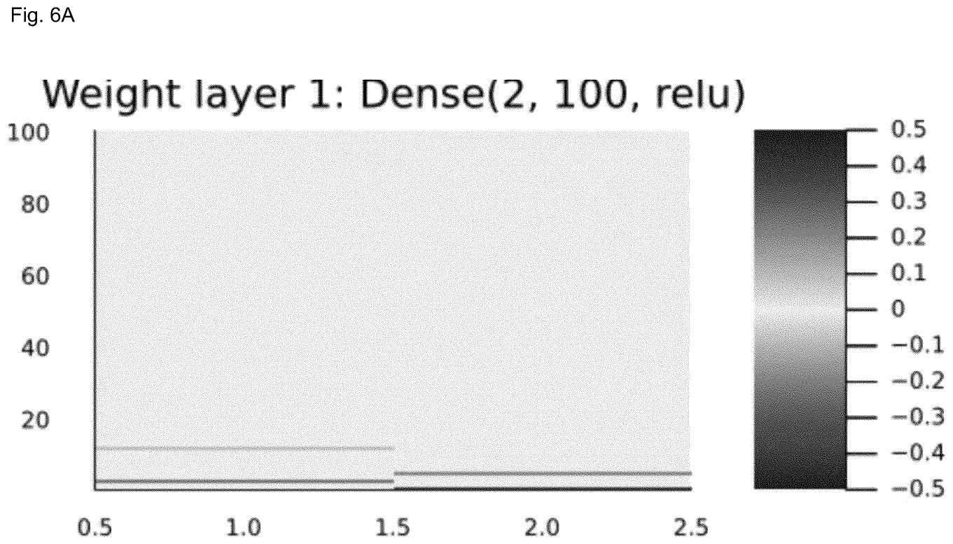

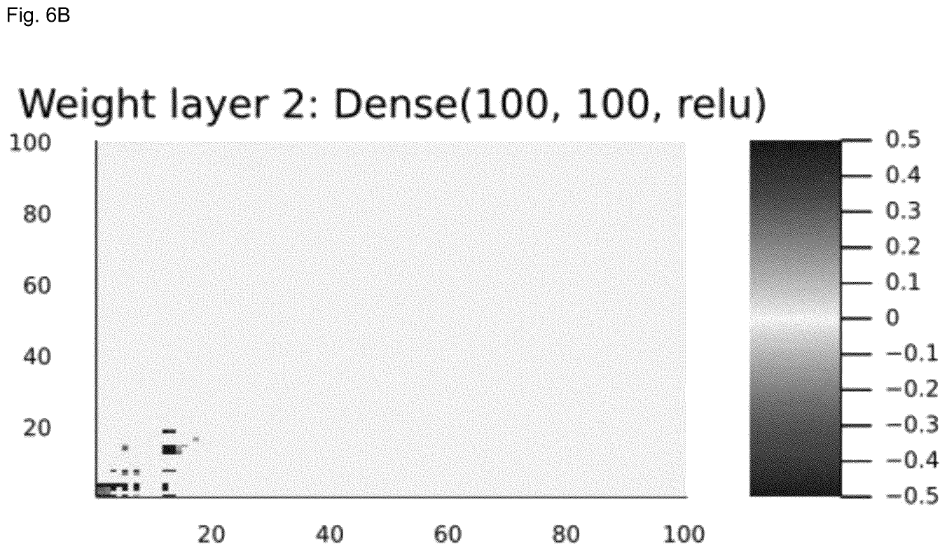

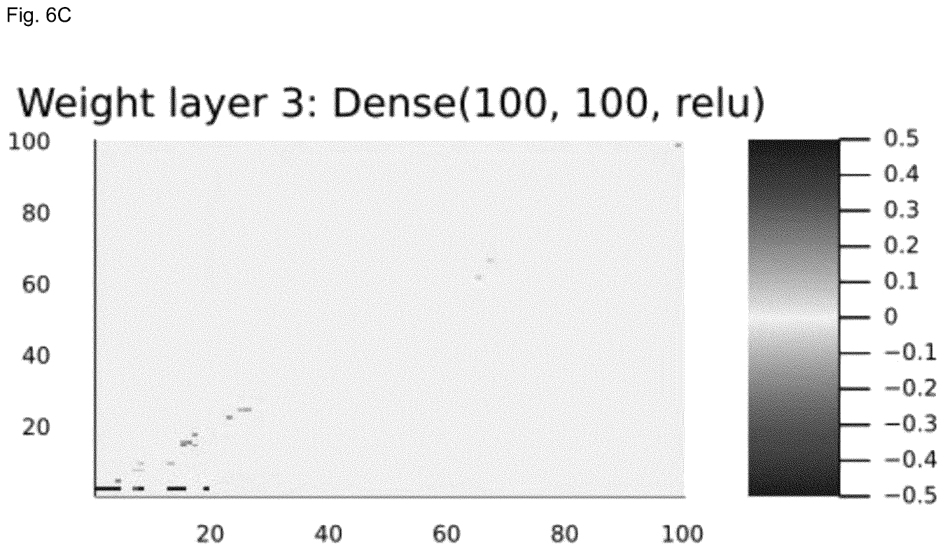

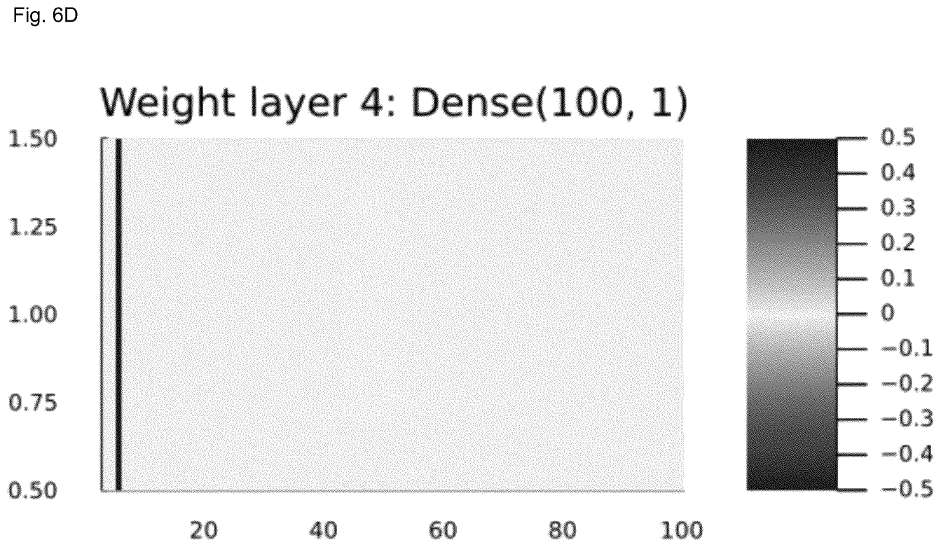

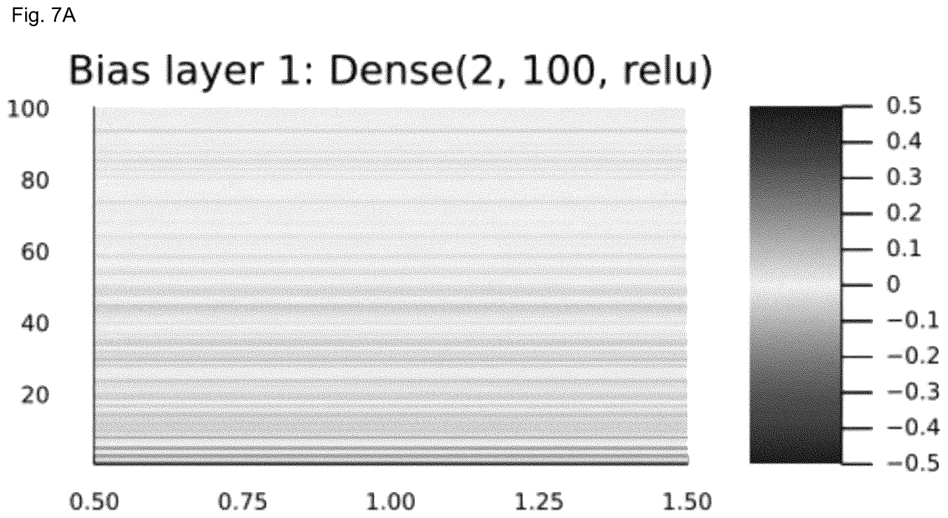

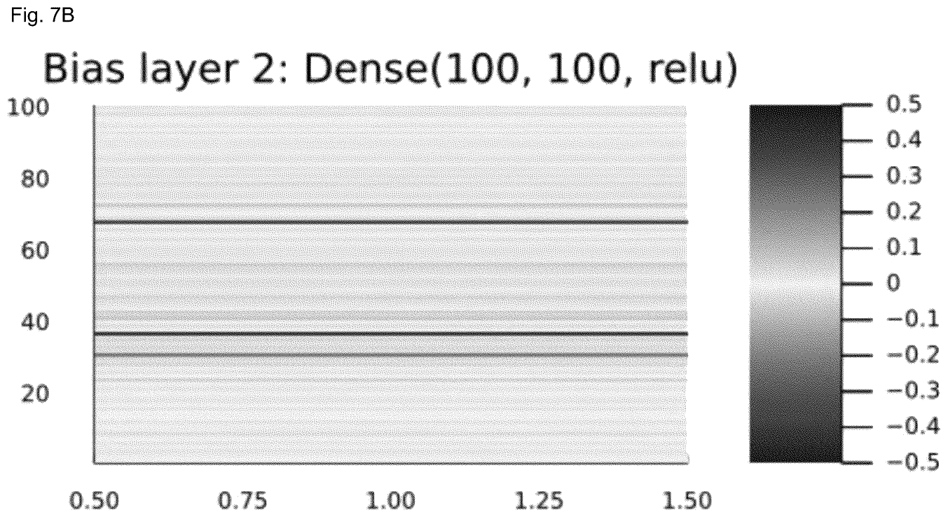

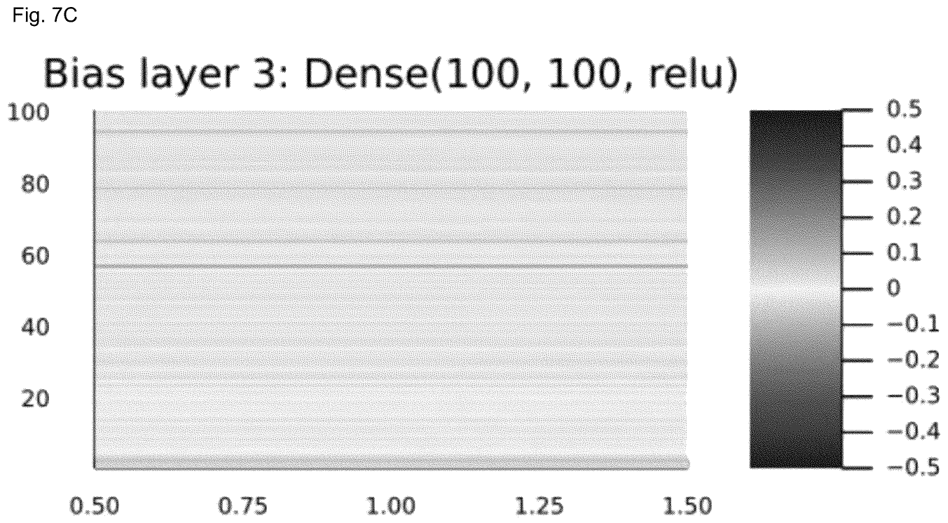

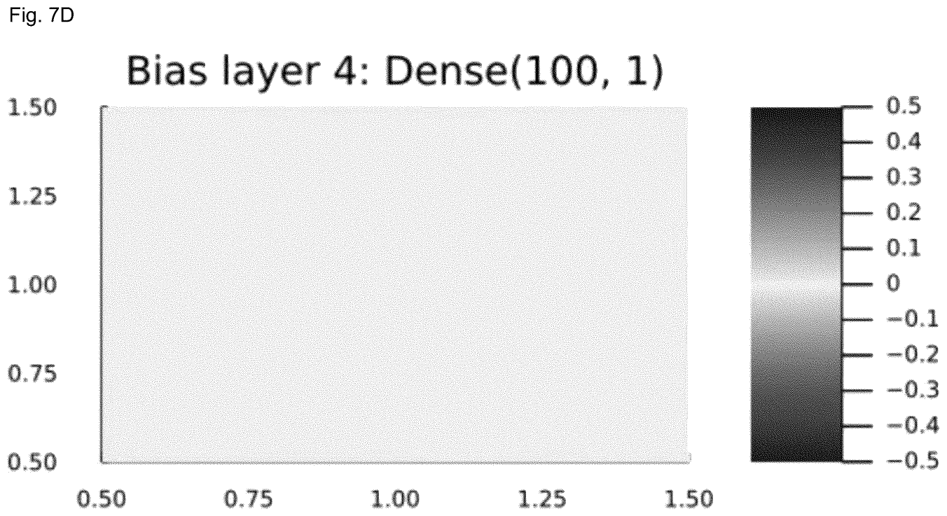

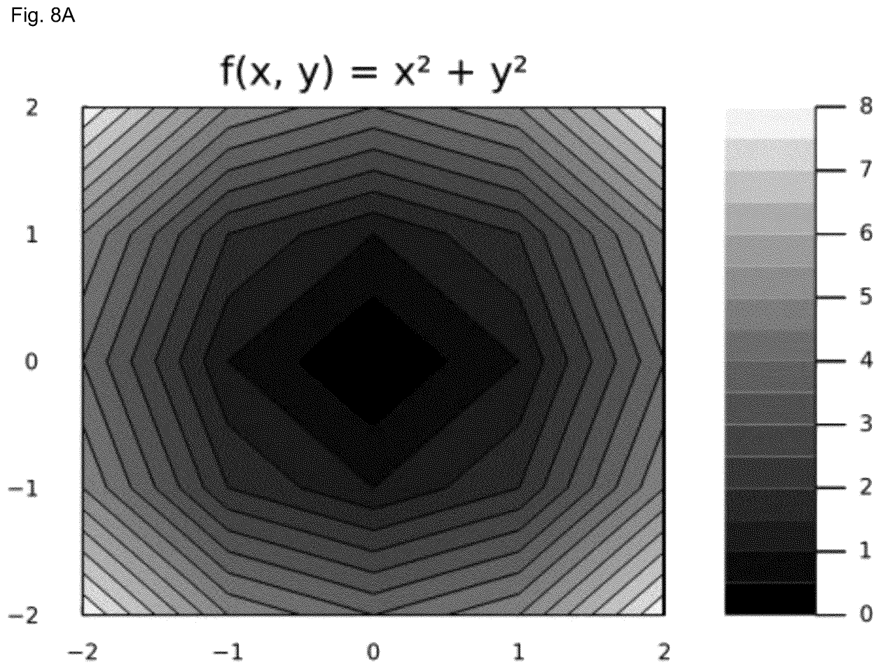

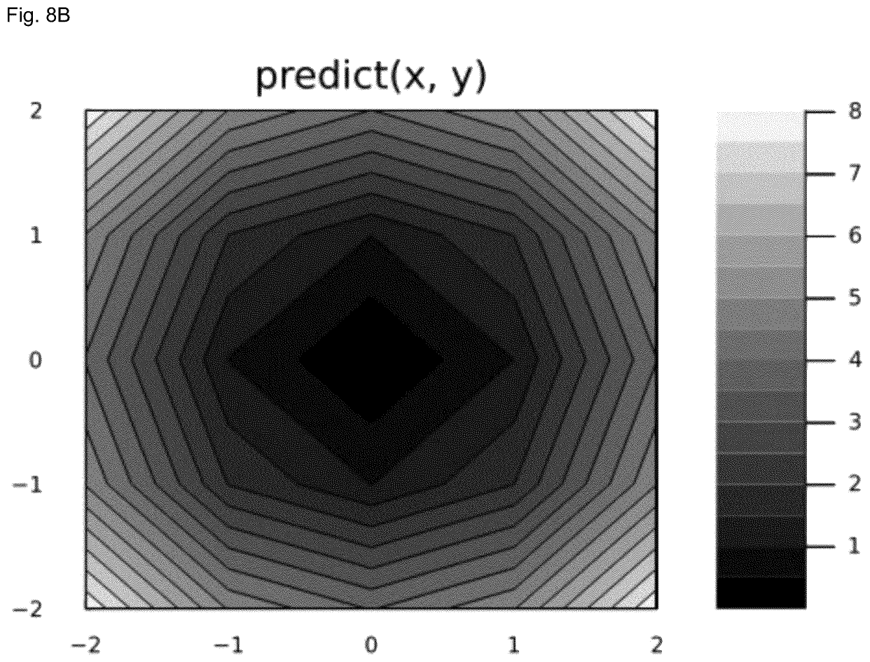

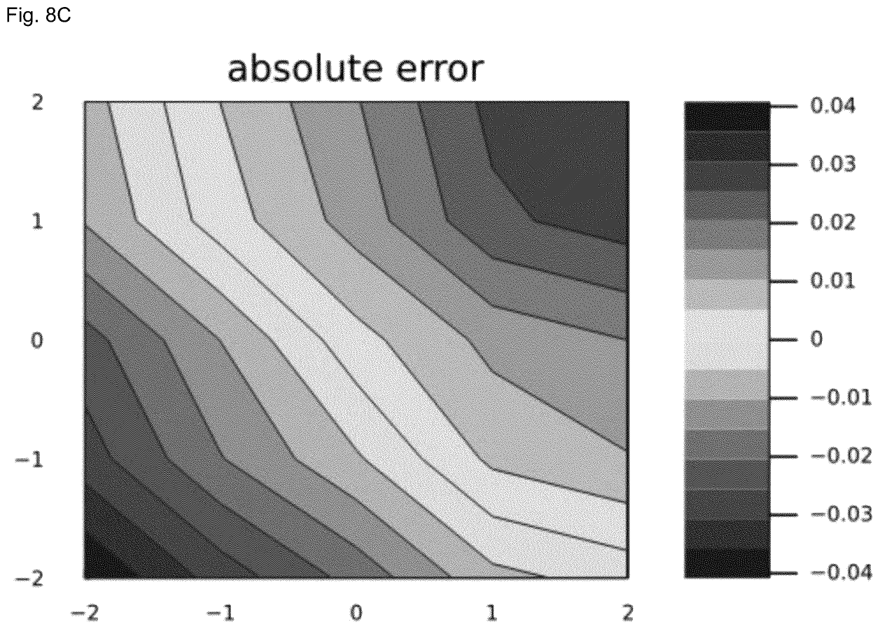

One aspect of the technology involves compressing the neural network so it can be implemented as efficiently as possible in hardware. This can be accomplished by factoring in the hardware costs. By way of example, the half-perimeter wire-length (HPWL) can be used for the routing cost. When the neural network is trained according to the hardware cost as described herein, the results can change dramatically. This can be seen in FIGS. 6A-D with regard to weights for the four neural network layers, FIGS. 7A-D with regard to biasing for the layers, and FIGS. 8A-C, which illustrates a plot of the function (FIG. 8A), a plot of the output predict (x,y) of the neural network (FIG. 8B), and the absolute error (FIG. 8C).

In contrast to the above, it can be seen that the cost for long routes leads to an enforcement of sparsity here. By way of example, the routing distance with weights greater than 0.05 was 502,720 for the prior approach in FIGS. 3A-D, while for FIGS. 6A-D the routing distance with weights greater than 0.05 is 307 (more than 1600× smaller). Moreover, the number of weights with magnitude greater than 0.05 in the initial example was 7673, whereas it was 72 (over 100× smaller) in the hardware cost-trained approach.

Finding the right balance between prediction loss and implementation loss can be done be slowly ramping up the implementation loss with some multiplication factor (α). Thus:

loss=prediction_loss+(α*implementation_loss)

The approach can then find a sweet spot by trading off accuracy versus sparsity. The plots were created showing a good trade-off between accuracy degradation and compression of the matrix. In the actual implementation, the following were used:

$$dist\_ij = 1 + \vert i - j \vert ,$$

$$implementation\_loss ( W ) = sum\_ij sqrt ( \vert w\_ij \vert ) ⋆ dist\_ij / ( nrow ⋆ ncol ) ,$$

where nrow and ncol are the number of rows and columns in the weight matrix W.

Viewing the two examples for implementing the function together, it can be seen that if one were to train a network without hardware cost, then part of the final calculation may look like, by way of example, 3*x−3*x. In contrast, if one were to implement that in hardware it would be extremely beneficial to remove all of the parts that would cancel each other out, because the design may get worse for every operation you implement, e.g., from the standpoints of power consumption, component size, speed of operation, etc. The hardware cost is what regularizes these types of expressions and eliminates them.

For instance, a systolic array would execute all multiply-accumulates that need to happen in a dense-matrix multiply. In contrast, specialized sparse implementation according to the approach herein does not need to do that anymore. So if the number of weights were reduced by 100×, then that would mean 100× fewer multiply-accumulates need to happen to implement the function of the trained neural network. That would be equivalent to 100× less power for such operations.

Thus, if there were something like 3*x−3*x, the hardware cost would create a gradient towards zero for these terms, so in the next iteration they would be something like 2.9*x−2.9*x. But since they do not contribute to the prediction loss (because they cancel), that means that there is no gradient that tries to keep them at 3*x−3*x and so eventually they would disappear during neural network the training phase. Note that when an extra term is added to a loss function, the prediction loss will become slightly worse. So there is effectively a choice of how much hardware cost savings to achieve versus less accurate predictions. For instance, if factor A>1 were multiplied to the hardware cost, then the prediction loss would slowly get worse while the implementation efficiency would go up. A tradeoff can be made that also depends on the environment the network needs to run in. Thus, if the hardware implementation of the neural network is something intended to be run on an Internet of things (IoT) device or a small portable device, hardware efficiency may be weighted more heavily compared to an implementation on a workstation or server, where component size and/or power consumption are less limiting as factors of interest.

### Example System

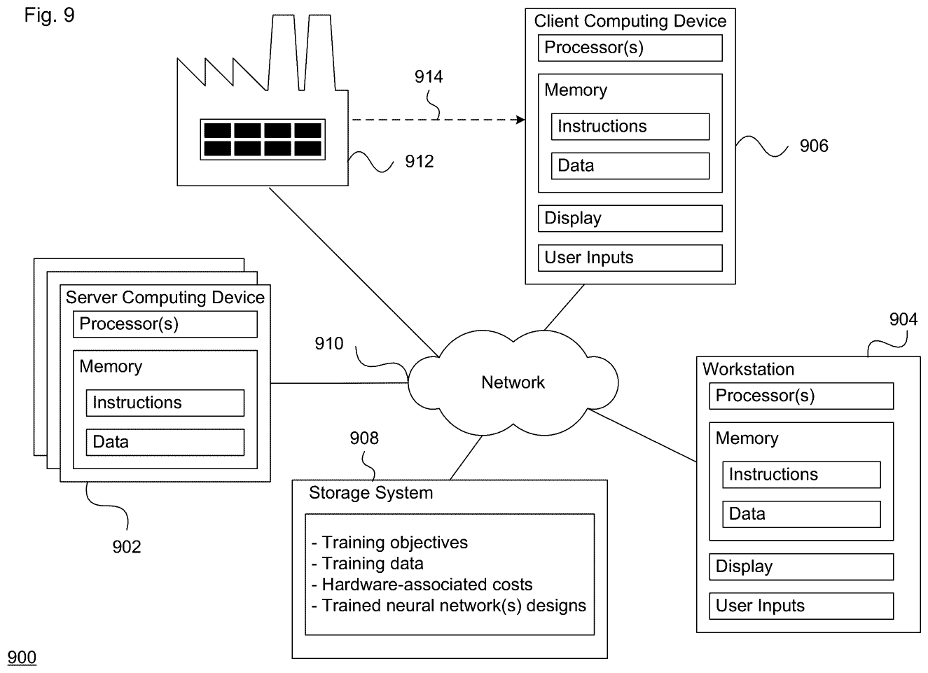

One example of a system configured to implement chip architecture gradient descent is shown in FIG. 9. In particular, FIG. 9 is a functional diagram, of an example system 900 that includes a plurality of computing devices 902, 904, 906 and a storage system 908 connected via a network 910. System 900 may also include a fabrication facility 912 that is configured to produce hardware such as integrated circuits or FPGAs designed according to the approaches described herein. As shown in FIG. 9, each of computing devices 902, 904 and 906 may include one or more processors, memory, data and instructions.

By way of example, the one or more processors may be any conventional processors, such as commercially available central processing units (CPUs), graphical processing units (GPUs) or tensor processing unites (TPUs). Alternatively, the one or more processors may include a dedicated device such as an ASIC or other hardware-based processor. As shown in FIG. 9, the memory for each computing device stores information accessible by the one or more processors, including instructions and data that may be executed or otherwise used by the processor(s). The memory may be of any non-transitory type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance.

The data may be retrieved, stored or modified by processor in accordance with the instructions. For instance, although the claimed subject matter is not limited by any particular data structure, the data may be stored in computing device registers, in a relational database as a table having a plurality of different fields and records, XML documents or flat files, etc. The data may also be formatted in any computing device-readable format.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 900 and/or the fabrication facility 912.

The various computing devices may communicate directly or indirectly via one or more networks, such as network 910. The network 910 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 902 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 902 may include one or more server computing devices that are capable of communicating with computing devices 904, 906 and the fabrication facility 912 via the network 910. In some examples, client computing device 904 may be an engineering workstation used by a developer to perform circuit design and/or other processes for chip architecture gradient descent, as well as fabrication of integrated circuits, FPGAs or other devices that incorporate neural networks that are tailored based on hardware criteria as discussed herein. Client computing device 906 may also be used by a developer, for instance to identify or prepare system requirements for neural network hardware constraints, or manage the manufacturing process with the fabrication facility 912. Alternatively, the client computing device(s) 914 may be made by the fabrication facility 912 (as shown by arrow 914).

Storage system 908 can be of any type of computerized storage capable of storing information accessible by the server computing devices 902, 904 and/or 906, such as a hard-drive, memory card, ROM, RAM, DVD, CD-ROM, flash drive and/or tape drive. In addition, storage system 908 may include a distributed storage system where data is stored on a plurality of different storage devices which may be physically located at the same or different geographic locations. Storage system 908 may be connected to the computing devices via the network 910 as shown in FIG. 9, and/or may be directly connected to or incorporated into any of the computing devices.

Storage system 908 may store various types of information. For instance, the storage system 908 may store training objectives, training data and/or hardware-associated costs to be used when generated a trained neural network. The storage system 908 may also maintain designs for trained neural networks, such as a sparse matrix-vector multiplication representation which can then be implemented in hardware by the fabrication facility 912.

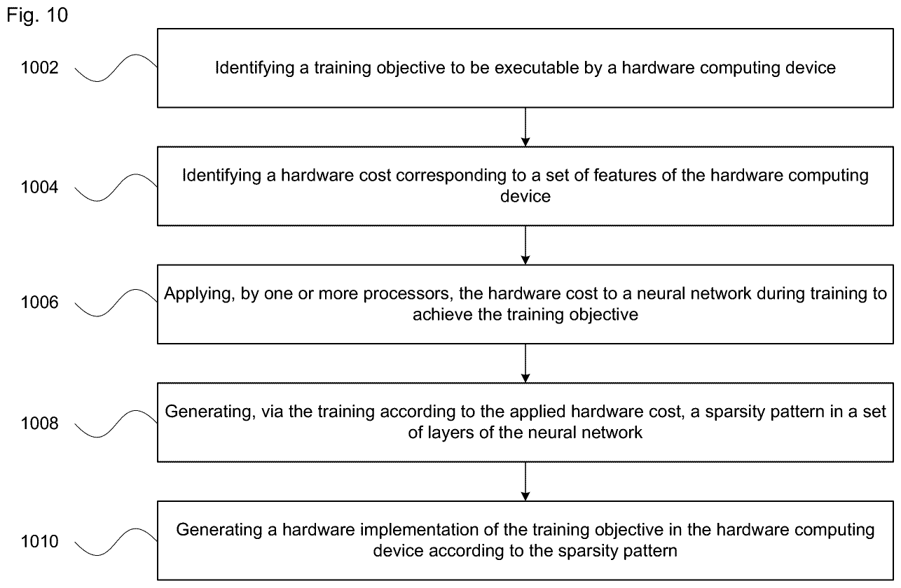

FIG. 10 illustrates an example method 1000 in accordance with the above discussion. At block 1002 the method includes identifying a training objective to be executable by a hardware computing device, and at block 1004 identifying a hardware cost corresponding to a set of features of the hardware computing device. Then at block 1006, the method includes applying, by one or more processors, the hardware cost to a neural network during training to achieve the training objective. At block 1008 the method includes generating, via the training according to the applied hardware cost, a sparsity pattern in a set of layers of the neural network. And at block 1010 the method includes generating a hardware implementation of the training objective in the hardware computing device according to the sparsity pattern.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A method, comprising:
identifying a training objective to be executable by a hardware computing device;
identifying a hardware cost corresponding to a set of features of the hardware computing device;
applying, by one or more processors, the hardware cost to a neural network during training to achieve the training objective;
generating, via the training according to the applied hardware cost, a sparsity pattern in a set of layers of the neural network; and
generating a hardware implementation of the training objective in the hardware computing device according to the sparsity pattern.

2. The method of claim 1, wherein the sparsity pattern is generated in one or more layers of the set of layers of the neural network based on adjustment of weights or biases in the one or more layers.

3. The method of claim 2, wherein the adjustment includes pruning one or more of the weights in the one or more layers.

4. The method of claim 2, wherein the adjustment further includes pruning routes in the one or more layers.

5. The method of claim 4, further comprising varying a pruning threshold for pruning the routes.

6. The method of claim 1, wherein the sparsity pattern is generated by training a loss function that accounts for a prediction loss and the applied hardware cost.

7. The method of claim 6, wherein training the loss function is performed by applying a gradient descent approach to minimize the loss function.

8. The method of claim 1, wherein the sparsity pattern is generated by training a loss function to account for the hardware cost.

9. The method of claim 1, wherein the hardware cost includes at least one of a logic cost or a set of spatiotemporal costs.

10. The method of claim 9, wherein the set of spatiotemporal costs includes at least one of a placement cost or a routing cost.

11. The method of claim 10, wherein the at least one of the placement cost or the routing cost includes one or more factors including area, timing, or power.

12. The method of claim 1, wherein the hardware computing device is a field-programmable gate array (FPGA) device.

13. The method of claim 1, wherein the hardware computing device is an application-specific integrated circuit (ASIC) device.

14. The method of claim 1, wherein the training objective to be executable by the hardware computing device is a non-linear function.

15. A system, comprising:
memory configured to store at least one of a training objective, a hardware cost, or a hardware implementation of the training objective; and
one or more processors operatively coupled to the memory, the one or more processors being configured to:
identify the training objective to be executable by a hardware computing device;
identify the hardware cost corresponding to a set of features of the hardware computing device;
apply the hardware cost to a neural network during training to achieve the training objective;
generate via the training according to the applied hardware cost, a sparsity pattern in a set of layers of the neural network; and
generate the hardware implementation of the training objective in the hardware computing device according to the sparsity pattern.

16. The system of claim 15, wherein the sparsity pattern is generated in one or more layers of the set of layers of the neural network based on adjustment of weights or biases in the one or more layers.

17. The system of claim 15, wherein the sparsity pattern is generated by training a loss function that accounts for a prediction loss and the applied hardware cost.

18. The system of claim 15, wherein the sparsity pattern is generated by training a loss function to account for the hardware cost.

19. The system of claim 15, wherein the hardware cost includes at least one of a logic cost or a set of spatiotemporal costs.

20. A non-transitory computer-readable medium having instructions stored thereon, the instructions, when executed by one or more processors of a computing system, performing a method comprising:
identifying a training objective to be executable by a hardware computing device;
identifying a hardware cost corresponding to a set of features of the hardware computing device;
applying the hardware cost to a neural network during training to achieve the training objective;
generating, via the training according to the applied hardware cost, a sparsity pattern in a set of layers of the neural network; and
generating a hardware implementation of the training objective in the hardware computing device according to the sparsity pattern.
